(19) United States
(12) Patent Application Publication
(10) Pub. No.: US 2022/0025485 A1
(43) Pub. Date: Jan. 27, 2022

(54) CUSTOM TITANIUM ALLOY, TI-64, 23+

(71) Applicant: Carpenter Technology Corporation, Philadelphia, PA (US)

(72) Inventors: Charles Frederick YOLTON, Moon Twp., PA (US); Eric BONO, Philadelphia, PA (US)

(21) Appl. No.: 17/495,127

(22) Filed: Oct. 6, 2021

Related U.S. Application Data
(63) Continuation of application No. 16/038,284, filed on Jul. 18, 2018.
(60) Provisional application No. 62/533,695, filed on Jul. 18, 2017.

(51) Int. Cl. C22C 1/04; B33Y 70/00; C22C 14/00

(52) U.S. Cl. CPC C22C 1/0458; B22F 10/20; C22C 14/00; B33Y 70/00

(57) ABSTRACT

This disclosure relates to a new alloy and methods of making same. The new alloy is an enhanced strength Ti-6Al-4V Grade 23+ titanium alloy having the following composition by weight percent: Aluminum —6.0 wt % to 6.5 wt %; Vanadium —4.0 wt % to 4.5 wt %; Iron —0.15 wt % to 0.25 wt %; Oxygen —0.00 wt % to 0.10 wt %; Nitrogen —0.01 wt % to 0.03 wt %; Carbon —0.04 wt % to 0.08 wt %; Hydrogen —0.0000 wt % to 0.0125 wt %; Other Elements, each —0.0 wt % to 0.1 wt %; Other Elements, total —0.0 wt % to 0.4 wt %; and Titanium—Balance.

### CROSS-REFERENCE TO RELATED APPLICATIONS

The present application claims the priority of Provisional Application No. 62/533,695 filed on Jul. 18, 2017 and entitled “Custom Titanium Alloy, Ti-64, 23+, For 3-D Printing” the content of which is incorporated by reference herein in its entirety.

### BACKGROUND OF THE INVENTION

### I. Field of the Invention

3-D printing technology has advanced into mainstream manufacturing for polymer based material systems and has caused a revolution in computer based manufacturing. Polymers based 3-D manufacturing maturation started with basic printing technology and existing polymer formulations. As it matured, the technology and polymer formulations evolved synergistically to deliver desired performance. Metals based 3-D printing is less mature but is beginning to follow a rapid growth curve. The metals printing technologies have narrowed primarily to powder-bed printing systems based on e-beam, and laser direct melt and binder-jet technologies. Due to being in the early stages of maturation, little has been done to customize alloy composition to optimize overall 3-D manufactured part performance. Of the alloys being applied, alloys such as titanium are among the least mature in this respect.

### II. Background

Problem: A major cost driver for all three primary 3-D manufacturing methods for titanium parts is the cost of titanium powder. Thus, the efficient use of the titanium powder is essential to successful market expansion of that product. The powder bed printing methods utilize a build box in which the component is built up layer by layer from powder. At completion, the build box is full of powder and the component produced is within the box filled with the powder. After printing, the loose powder is removed from around the part and finishing operations are performed on the part. Since often only a small fraction of the powder in the build box is incorporated into the part, there is a significant incentive to recycle the excess high cost powder.

Of the three primary 3-D printing methods applied to titanium alloys, the direct melt technologies based on e-beam and laser melting represent most titanium part manufacture but the excess titanium powder suffers from oxygen pickup each cycle through the process. The most common alloy for titanium parts is Ti-6AI-4V, ASTM Grade 5 with a maximum allowable oxygen content of 0.2 wt %. A more challenging grade of Ti-6AI-4V is Grade 23 with a much lower oxygen limit of 0.13 wt %. Since manufacturers want to start with as low an oxygen content in the powder as possible to enable the maximum number of re-use cycles for the powder before the oxygen content exceeds the specification limit, Ti-6AI-4V, Grade 23 represents a greater challenge to powder recycling than Ti-6AI-4V, Grade 5.

### BRIEF SUMMARY OF THE INVENTION

Solution: One aspect of this disclosure is directed to an enhanced strength Ti-6Al-4V Grade 23+ titanium alloy (also referred to in this disclosure as “Ti-6Al-4V Grade 23+ titanium alloy” or “Ti-6Al-4V Grade 23+”) having the following composition by weight percent: Aluminum—6.0 wt % to 6.5 wt %; Vanadium—4.0 wt % to 4.5 wt %; Iron—0.15 wt % to 0.25 wt %; Oxygen—0.00 wt % to 0.10 wt %; Nitrogen—0.01 wt % to 0.03 wt %; Carbon—0.04 wt % to 0.08 wt %; Hydrogen—0.0000 wt % to 0.0125 wt %; Other Elements, each—0.0 wt % to 0.1 wt %; Other Elements, total—0.0 wt % to 0.4 wt %; and Titanium—Balance.

In any aspect of this disclosure, “balance” refers to the remaining wt % which when added to the wt % of all the other components results in a total of 100%. In this case, “Titanium—Balance” indicates that Titanium is the remaining component and that all the components added together results in 100 wt %.

In any aspect of this disclosure, the enhanced strength Ti-6Al-4V Grade 23+ titanium alloy can have 0.00 wt % to 0.10 wt % Oxygen (as described above); 0.00 wt % to 0.06 wt % Oxygen; 0.01 wt % to 0.10 wt % Oxygen; or 0.01 wt % to 0.06 wt % oxygen. The enhanced strength Ti-6Al-4V Grade 23+ titanium alloy described in any aspect of this disclosure can be a powder alloy; or a starting bar stock. The enhanced strength Ti-6Al-4V Grade 23+ titanium alloy described in any aspect of this disclosure can have less than or equal to 0.10 wt % Oxygen, and, at the same time, having the same or greater strength as a Ti-6Al-4V Grade 23 alloy. The Ti-6Al-4V Grade 23+ alloy results from controlling the following combination of elements in the Ti-6Al-4V Grade 23 alloy: Aluminum; Iron; Nitrogen; and Carbon. That is, the combination of the elements can be, for example, Aluminum—6.0 wt % to 6.5 wt %; Iron—0.15 wt % to 0.25 wt %; Nitrogen—0.01 wt % to 0.03 wt %; and Carbon—0.04 wt % to 0.08 wt %.

Another aspect related to a method of increasing the strength or reducing the oxygen content of Ti-6Al-4V Grade 23 titanium alloy to produce Ti-6Al-4V Grade 23+ titanium alloy, the method comprising adjusting the following combination of elements in the Ti-6Al-4V Grade 23 alloy: Aluminum; Iron; Nitrogen; and Carbon. Adjusting the combination in this disclosure refers to adjusting the wt %, including adjusting the wt % to zero, of an element. For example, adjusting the combination includes adjusting Aluminum; Iron; Nitrogen; and Carbon to the following wt %: Aluminum—6.0 wt % to 6.5 wt %; Iron—0.15 wt % to 0.25 wt %; Nitrogen—0.01 wt % to 0.03 wt %; Carbon—0.04 wt % to 0.08 wt %. As another example, adjusting the combination includes adjusting to the following wt %: Aluminum—6.0 wt % to 6.5 wt %; Vanadium—4.0 wt % to 4.5 wt %; Iron—0.15 wt % to 0.25 wt %; Oxygen—0.00 wt % to 0.10 wt %; Nitrogen—0.01 wt % to 0.03 wt %; Carbon—0.04 wt % to 0.08 wt %; Hydrogen—0.0000 wt % to 0.0125 wt %; Other Elements, each—0.0 wt % to 0.1 wt %; Other Elements, total—0.0 wt % to 0.4 wt %; and Titanium—Balance. In this disclosure, other elements refer to one or more elements other than the elements listed in the formula, composition or claim being discussed. “Other elements, each” refers to a single element which is one element which is not listed in the formula, composition or claim being discussed.

In any of the methods of this disclosure, adjusting the combination of elements may contain an optional step performed before, after, or during other adjustments. The optional step is adjusting the oxygen wt % of the final composition—that is, adjusting the composition of Ti-6Al-4V Grade 23 to produce Ti-6Al-4V Grade 23+. The oxygen wt % may be 0.00 wt % to 0.10 wt % Oxygen; 0.00 wt % to 0.06 wt % Oxygen; 0.01 wt % to 0.10 wt % Oxygen; or 0.01 wt % to 0.06 wt % oxygen.

One aspect of the methods and composition of this disclosure is that an improved alloy, Ti-6Al-4V Grade 23+ titanium alloy, is produced. In one aspect, the Ti-6Al-4V Grade 23+ titanium alloy has the same strength as the Ti-6Al-4V Grade 23 titanium alloy but with a lower oxygen content. Another aspect of the methods and composition of this disclosure is that an alloy which is stronger than Ti-6Al-4V Grade 23 titanium alloy, is product—this stronger alloy being Ti-6Al-4V Grade 23+ titanium alloy. Significantly, this stronger alloy (Ti-6Al-4V Grade 23+ titanium alloy) does not contain more oxygen wt % than that of Ti-6Al-4V Grade 23 titanium alloy. Another aspect of the methods and composition of this disclosure is that both effects are seen. That is, the method increases the strength of Ti-6Al-4V Grade 23 titanium alloy to produce Ti-6Al-4V Grade 23+ titanium alloy, and, wherein the Ti-6Al-4V Grade 23+ titanium alloy is stronger but has the same or less oxygen wt % than the Ti-6Al-4V Grade 23 titanium alloy.

### DETAILED DESCRIPTION OF THE INVENTION

Manufacturers, for the reasons described above, want as low a starting oxygen content as possible, but at the same time, the customers for the 3-D printed Ti-6AI-4V parts want maximum strength. The typical approach to achieve high strength Ti-6AI-4V parts is to increase oxygen content close to the upper limit leaving not much room for oxygen drift with alloy Ti-6AI-4V Grade 23 oxygen upper limit of 0.13%. Using oxygen as the strengthening agent would, of course, result in the minimum number of re-use cycles since the oxygen content would quickly exceed that allowed in the specification. This creates a need for a custom Ti-6AI-4V Grade 23 powder alloy composition to compete with the standard T-6AI-4V Grade 23 composition and achieve high strength, approaching that of Grade 5 while having an initial low oxygen content to allow for the maximum number of re-use cycles.

Reviewing the ASTM specification for Ti-6Al-4V Grade 23 alloy, Applicant has discovered that other strength enhancing elements in the alloy specification may be used to enhance strength independently of oxygen. Table 1 illustrates the standard chemical composition specification for the Ti-6Al-4V Grade 23 alloy as defined in the ASTM B348 specification. Oxygen is typically used to enhance strength because it is easy and as a single element it has a significant effect on strength. Other potential strength enhancers include aluminum, iron, nitrogen and carbon. Nitrogen is a more potent strengthener than oxygen but the allowed level is much lower. The other elements in this group have lesser effects on strength. Applicants hypothesize that these elements are not significantly affected by the 3-D printing process, and a controlled combination of these elements within the Grade 23 specification can achieve the same strength enhancing results as oxygen enhancement.

TABLE 1
Ti-6Al-4V ASTM B348 Grade 23

| Element | Min wt % | Max wt % |
|---|---|---|
| Aluminum | 5.5 | 6.5 |
| Vanadium | 3.5 | 4.5 |
| Iron | — | 0.25 |
| Oxygen | | 0.13 |
| Nitrogen | | 0.03 |
| Carbon | | 0.08 |
| Hydrogen | | 0.0125 |
| Other Elements, each | | 0.10 |
| Other Elements, total | | 0.40 |
| Titanium | | Balance |

Composition of Ti-6Al-4V Grade 23 titanium alloy as defined in the ASTM B348 specification.

Based on Applicant's hypothesis, Applicant has formulated a novel composition. Table 2 illustrates this novel composition—the Carpenter specification for Ti-6Al-4V Grade 23+ titanium powder alloy. This Ti-6Al-4V Grade 23+ titanium powder alloy comprises aluminum, iron, nitrogen and carbon composition ranges that, when combined, provide the desired strength enhancement in the alloy without a high initial oxygen content. Therefore, the baseline strength of 3-D printed Ti-6Al-4V parts made with Carpenter Ti-6Al-4V Grade 23+ would be the same as higher oxygen Ti-6Al-4V Grade 23 parts but would have the lower oxygen desired for maximum re-use of the powder. Based on predictive modeling the strength of Grade 23+ can approach that of Ti-6Al-4V Grade 5. The strength would further increase as the powder picked up oxygen because of the re-use resulting in an overall higher strength curve and a significantly lower cost of production.

TABLE 2
Grade 23+, Improved Strength Low Oxygen Ti-6Al-4V Powder

| Element | Min wt % | Max wt % |
|---|---|---|
| Aluminum | 6.0 | 6.5 |
| Vanadium | 4.0 | 4.5 |
| Iron | 0.15 | 0.25 |
| Oxygen | — | 0.10 |
| Nitrogen | 0.01 | 0.03 |
| Carbon | 0.04 | 0.08 |
| Hydrogen | — | 0.0125 |
| Other Elements, each | — | 0.10 |
| Other Elements, total | — | 0.40 |
| Titanium | — | Balance |

Composition of Carpenter Ti-6Al-4V Grade 23+ enhanced strength titanium alloy.

Unless defined otherwise, all terms used herein have the same meaning as are commonly understood by one of skill in the art to which this invention belongs. All patents, patent applications and publications referred to throughout the disclosure herein are incorporated by reference in their entirety. In the event that there is a plurality of definitions for a term herein, those in this disclosure prevail.

While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

1. An enhanced strength Ti-6Al-4V Grade 23+ titanium alloy having the following composition by weight percent:
Aluminum—6.0 wt % to 6.5 wt %;
Vanadium—4.0 wt % to 4.5 wt %;
Iron—0.15 wt % to 0.25 wt %;
Oxygen—0.00 wt % to 0.10 wt %;
Nitrogen—0.01 wt % to 0.03 wt %;
Carbon—0.04 wt % to 0.08 wt %;
Hydrogen—0.0000 wt % to 0.0125 wt %;
Other Elements, each—0.0 wt % to 0.1 wt %;
Other Elements, total—0.0 wt % to 0.4 wt %; and
Titanium—Balance.

2. The enhanced strength Ti-6Al-4V Grade 23+ titanium alloy of claim 1 having
0.00 wt % to 0.06 wt % Oxygen;
0.01 wt % to 0.10 wt % Oxygen; or
0.01 wt % to 0.06 wt % Oxygen.

3. The enhanced strength Ti-6Al-4V Grade 23+ titanium alloy of claim 1 which is a powder alloy.

4. The enhanced strength Ti-6Al-4V Grade 23+ titanium alloy of claim 1 which is a starting bar stock.

5. An enhanced strength Ti-6Al-4V Grade 23+ alloy composition having less than or equal to 0.10 wt % Oxygen, having the same or greater strength as a Ti-6Al-4V Grade 23 alloy, wherein the Ti-6Al-4V Grade 23+ alloy results from controlling the following combination of elements in the Ti-6Al-4V Grade 23 alloy:
Aluminum;
Iron;
Nitrogen; and
Carbon.

6. An enhanced strength Ti-6Al-4V Grade 23+ alloy composition of claim 5, wherein the weight percent of the elements is:
Aluminum—6.0 wt % to 6.5 wt %;
Iron—0.15 wt % to 0.25 wt %;
Nitrogen—0.01 wt % to 0.03 wt %; and
Carbon—0.04 wt % to 0.08 wt %.

7. The enhanced strength Ti-6Al-4V Grade 23+ titanium alloy of claim 5 which is a powder alloy.

8. The enhanced strength Ti-6Al-4V Grade 23+ titanium alloy of claim 5 which is a starting bar stock.

9. The enhanced strength Ti-6Al-4V Grade 23+ titanium alloy of claim 5 having
0.00 wt % to 0.06 wt % Oxygen;
0.01 wt % to 0.10 wt % Oxygen; or
0.01 wt % to 0.06 wt % Oxygen.

10. A method of increasing the strength or reducing the Oxygen content of Ti-6Al-4V Grade 23 titanium alloy to produce Ti-6Al-4V Grade 23+ titanium alloy, the method comprising adjusting the following combination of elements in the Ti-6Al-4V Grade 23 alloy:
Aluminum;
Iron;
Nitrogen; and
Carbon.

11. The method of claim 10 wherein the Ti-6Al-4V Grade 23+ titanium alloy has the following composition by weight percent:
Aluminum—6.0 wt % to 6.5 wt %;
Vanadium—4.0 wt % to 4.5 wt %;
Iron—0.15 wt % to 0.25 wt %;
Oxygen—0.00 wt % to 0.10 wt %;
Nitrogen—0.01 wt % to 0.03 wt %;
Carbon—0.04 wt % to 0.08 wt %;
Hydrogen—0.0000 wt % to 0.0125 wt %;
Other Elements, each—0.0 wt % to 0.1 wt %;
Other Elements, total—0.0 wt % to 0.4 wt %; and
Titanium—Balance.

12. The method of claim 10 further comprising a step of adjusting the composition of Ti-6Al-4V Grade 23 alloy to have
0.00 wt % to 0.06 wt % Oxygen;
0.01 wt % to 0.10 wt % Oxygen; or
0.01 wt % to 0.06 wt % Oxygen.

13. The method of claim 10 wherein the method reduces the Oxygen content of Ti-6Al-4V Grade 23 titanium alloy to produce Ti-6Al-4V Grade 23+ titanium alloy and wherein the Ti-6Al-4V Grade 23+ titanium alloy has the same strength as the Ti-6Al-4V Grade 23 titanium alloy.

14. The method of claim 10 wherein the method increases the strength of Ti-6Al-4V Grade 23 titanium alloy to produce Ti-6Al-4V Grade 23+ titanium alloy and wherein the Ti-6Al-4V Grade 23+ titanium alloy is stronger but has the same or less Oxygen wt % than the Ti-6Al-4V Grade 23 titanium alloy.

15. The method of claim 10 wherein the Ti-6Al-4V Grade 23+ titanium alloy is a powder alloy.

16. The method of claim 10 wherein the Ti-6Al-4V Grade 23+ titanium alloy is a starting bar stock.
